(19) United States
(12) Patent Application Publication
(10) Pub. No.: US 2025/0147868 A1
(43) Pub. Date: May 8, 2025

(54) COMPUTER-IMPLEMENTED METHOD AND SYSTEM FOR GENERATING A CONFIGURATION OF A VIRTUAL TEST

(71) Applicant: dSPACE GmbH, Paderborn (DE)

(72) Inventor: Markus DEPPE, Paderborn (DE)

(21) Appl. No.: 18/934,429

(22) Filed: Nov. 1, 2024

(30) Foreign Application Priority Data
Nov. 8, 2023 (DE) 102023130869.6

(51) Int. Cl. G06F 11/36

(52) U.S. Cl. CPC G06F 11/3688; G06F 11/3684

(57) ABSTRACT

A method for criteria-based generation of a configuration of a virtual test for testing automated driving functions of a vehicle includes: defining, by a configuration generation system, a dependency of configuration parameters on target variables of the virtual test; determining, by the configuration generation system, a test algorithm and/or parameter combinations for a relevant target variable; and specifying, by the configuration generation system, an application condition for the configuration parameters, at least one interval per parameter, and/or the test algorithm.

### CROSS-REFERENCE TO PRIOR APPLICATIONS

This application claims benefit to German Patent Application No. DE 102023130869.6, filed on Nov. 8, 2023, which is hereby incorporated by reference herein.

### FIELD

The present invention relates to a computer-implemented method for criteria-based generation of a configuration of a virtual test for testing automated driving functions of a vehicle.

The present invention further relates to a system for criteria-based generation of a configuration of a virtual test for testing automated driving functions of a motor vehicle.

### BACKGROUND

Driver assistance systems such as adaptive cruise control and/or functions for highly automated driving can be verified or validated using various test methods. In the process, hardware-in-the-loop methods, software-in-the-loop methods, simulations, and/or test drives can be used.

To generate test scenarios for simulations, test drives are carried out. The sensor data obtained as a result are then abstracted into a logical scenario.

“Szenario-Optimierung für die Absicherung von automatisierten und autonomen Fahrsystemen” [Scenario optimization for the validation of automated and autonomous driving systems] (Florian Hauer, B. Holzmüller, 2019) describes methods for verifying and validating automated and autonomous driving systems, in particular for finding suitable test scenarios for the virtual validation.

In this case, the test methodology includes the adaptation of a metaheuristic search to optimize scenarios. To do this, an appropriate search space and a suitable target function need to be defined. Parameterized, in particular logical, scenarios are derived starting from an abstract description of the functionality and applications of the system.

To parameterize logical scenarios for carrying out a virtual test for testing automated driving functions of a vehicle, what are known as intelligent test control (ITC) methods can then be used.

To optimally cover a predetermined parameter space, logical scenarios are conventionally parameterized in all dimensions on the assumption that all the configuration parameters in combination have an impact on all the target variables. This results in a high-dimensional monolithic ITC configuration and, as a result, high computational effort.

The configuration process for an ITC experiment conventionally involves requiring the user to specify a list of relevant parameters including their value ranges, a list of target functions (KPIs) including limit values, and the desired method (predefined algorithm for execution).

During execution, the ITC method is initiated with the aim of finding, within the set of possible parameter variations, those parameter variations defined as relevant by the target functions and their limit values.

To begin with, the configuration step is a very challenging abstraction step for the user in the light of its development problem, additionally, the knowledge of the implemented abstraction is not available for the ITC method and the evaluation of the results.

### SUMMARY

In an exemplary embodiment, the present invention provides a method for criteria-based generation of a configuration of a virtual test for testing automated driving functions of a vehicle. The method includes: defining, by a configuration generation system, a dependency of configuration parameters on target variables of the virtual test; determining, by the configuration generation system, a test algorithm and/or parameter combinations for a relevant target variable; and specifying, by the configuration generation system, an application condition for the configuration parameters, at least one interval per parameter, and/or the test algorithm.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a flowchart of a computer-implemented method for criteria-based generation of a configuration of a virtual test for testing automated driving functions of a vehicle according to an exemplary embodiment of the invention; and

FIG. 2 is a schematic view of a system for criteria-based generation of a configuration of a virtual test for testing automated driving functions of a vehicle according to an exemplary embodiment of the invention.

In the drawings, like reference signs designate like elements unless indicated otherwise.

### DETAILED DESCRIPTION

Exemplary embodiment of the invention improve upon ITC methods with respect to determining relevant parameter combinations, including parameter combinations that have a defined impact on the corresponding target variables of the virtual test for testing the automated driving functions of the vehicle.

Exemplary embodiments of the invention provide a method for generating a configuration of a virtual test for testing automated driving functions of a vehicle which makes it possible to incorporate, in the parameterization of logical scenarios, in particular parameter combinations that have a defined impact on the corresponding target variables of the virtual test for testing the automated driving functions of the vehicle.

In an exemplary embodiment, the invention provides a computer-implemented method for criteria-based generation of a configuration of a virtual test for testing automated driving functions of a vehicle. The method comprises defining a dependency of configuration parameters on target variables of the virtual test and determining a test algorithm and/or parameter combinations for the relevant target variable.

Furthermore, the method comprises specifying an application condition for the configuration parameters, at least one interval per parameter, and/or the test algorithm.

In a further exemplary embodiment, the invention provides a system for criteria-based generation of a configuration of a virtual test for testing automated driving functions of a motor vehicle. The system comprises a first arithmetic logic device, which is configured to define a dependency of configuration parameters on target variables of the virtual test.

Furthermore, the system comprises a second arithmetic logic device, which is configured to determine a test algorithm and/or parameter combinations for the relevant target variable, and a third arithmetic logic device, which is configured to specify an application condition for the configuration parameters, at least one interval per parameter, and/or the test algorithm.

In another further exemplary embodiment, the invention provides a computer-implemented method for performing a virtual test using a configuration according to an exemplary embodiment of the invention, wherein, if the target variable of a configuration exceeds a predetermined threshold value, the virtual test is terminated and/or specific parameter values of the configuration are modified.

In yet another further exemplary embodiment, the invention provides a computer program comprising program code for performing a method according to an exemplary embodiment of the invention for criteria-based generation of a configuration of a virtual test for testing automated driving functions of a vehicle when the computer program is executed on a computer.

In yet another further exemplary embodiment, the invention further provides a computer-readable data medium comprising program code of a computer program for performing at least parts of a method for criteria-based generation of a configuration of a virtual test for testing automated driving functions of a vehicle when the computer program is executed on a computer.

Exemplary embodiments of the present invention make it possible to introduce user knowledge for the parameterization of logical scenarios by determining the dependency of configuration parameters on target variables of the virtual test.

Therefore, by incorporating information from the user, advantageously the parameter space can be explored in a considerably more focused manner and the user can evaluate the results in a simpler manner.

Relationships can be derived, for example, from the test objective or the test specification, i.e., when there is a relationship between a configuration parameter and other target functions, this can be explicitly ignored since it is not within the test scope.

The method according to an exemplary embodiment of the invention incrementally queries and implements user knowledge, for example about scenario layers or the operational design domain (ODD) of the automated driving function (AD function, e.g., lane keeping). This results in a highly application-oriented and simultaneously efficient ITC configuration having a modular-hierarchical structure which is oriented toward the scenario layer or the ODD structure, for example.

According to an exemplary embodiment of the invention, it is provided that defining the dependency of the configuration parameters on the target variables of the virtual test for each target variable comprises determining first configuration parameters which have a significant impact on the relevant target variable of the virtual test and determining second configuration parameters which have an insignificant impact on the relevant target variable of the virtual test.

Therefore, in the parameterization of logical scenarios, a distinction can be drawn between configuration parameters which have a significant impact on the relevant target variable of the virtual test and those configuration parameters which have an insignificant impact on the relevant target variable of the virtual test.

According to another exemplary embodiment of the invention, it is provided that configuration parameters are classified as first configuration parameters when a difference in the relevant target variable between using and not using the configuration parameter exceeds a predetermined threshold value, and wherein configuration parameters are classified as second configuration parameters when the difference in the relevant target variable between using and not using the configuration parameter does not reach a predetermined threshold value.

Therefore, the above-mentioned metrics can be used to ascertain those configuration parameters which have a significant impact on the relevant target variable because they exceed the threshold value and those configuration parameters which have an insignificant impact on the relevant target variable because they do not reach the threshold value.

According to another exemplary embodiment of the invention, it is provided that specifying the application condition for the configuration parameters, at least one interval per parameter, and/or the test algorithm defines a point in time and/or time period for a parameter variation of the virtual test.

As a result, the point in time at which a parameter variation should be executed in a scenario can advantageously be automatically identified. In this case, the parameter variation is generally not executed over the entire duration of the scenario, but instead only in a time sub-interval, e.g., as part of a cut-in scenario, i.e., an ego vehicle moves into the lane in front of a fellow vehicle, or vice versa.

According to another exemplary embodiment of the invention, it is provided that the application condition is a predetermined parameter range and/or a start and end point of an event, in particular a driving maneuver, of the virtual test.

For example, the application condition thus advantageously defines a start condition and/or an end condition for an event, in particular a driving maneuver, of the virtual test being carried out or occurring.

According to another exemplary embodiment of the invention, it is provided that, by specifying a first test algorithm for a first target variable, a first configuration of the virtual test is carried out, and wherein, by specifying a second test algorithm for a second target variable, a second configuration of the virtual test is carried out, wherein the first configuration and the second configuration of the virtual test are assigned to an identical test case.

Therefore, an optimal test algorithm for the relevant target variable can be used. This results in two equivalent ITC configurations in parallel with one another which are nevertheless assigned to the same test case.

According to another exemplary embodiment of the invention, it is provided that the second configuration of the virtual test is linked to the first configuration of the virtual test by a hierarchy condition.

If configuration parameters, for example an environmental parameter such as intensity of precipitation, are in turn used in the application conditions for ITC configurations, this then results in dependencies between variation parameters of one ITC configuration and application conditions of another ITC configuration. These dependencies can then advantageously be used for a hierarchical ITC configuration.

According to another exemplary embodiment of the invention, it is provided that the hierarchy condition is provided by a configuration parameter of the first configuration that impacts at least one configuration parameter of the second configuration.

Here, global configuration parameters such as environmental conditions impact specific configuration parameters such as a roadway coefficient of friction.

According to another exemplary embodiment of the invention, it is provided that the configuration parameters apply to at least one vehicle sensor and the application condition applies to an error in the at least one vehicle sensor.

For example, a first configuration can apply to a sensor layer, a second configuration can apply to a content layer, and a third configuration can apply to a temporal layer. In this case, the temporal layer has a time reference.

According to another exemplary embodiment of the invention, it is provided that the configuration parameters apply to a digital exchange of information among vehicles or between vehicles and a transport infrastructure, to environmental conditions, in particular weather conditions, to maneuvers by road users, to static objects, in particular items, to the transport infrastructure, to a roadway geometry and/or to a roadway state in the virtual test.

For this purpose, the six-level model for scenario descriptions in accordance with the PEGASUS project may be used. Therefore, ITC configurations can be generated for configuration parameters of different layers in a targeted manner, which then allow for targeted parameter variation.

According to another exemplary embodiment of the invention, it is provided that the target variable is behavior of an ego vehicle, behavior of another road user, a time until a collision, and/or engagement or non-engagement of the automated driving function.

The target variable of the virtual test thus represents a metric for a test result of the virtual test.

The features described herein of a computer-implemented method for criteria-based generation of a configuration of a virtual test for testing automated driving functions of a vehicle are likewise applicable to a system according to an exemplary embodiment of the invention for criteria-based generation of a configuration of a virtual test for testing automated driving functions of a vehicle, and vice versa.

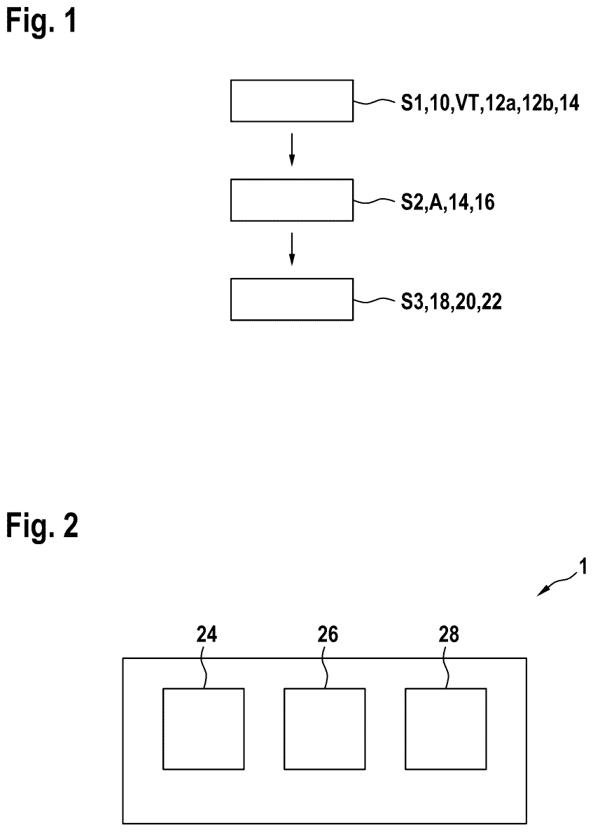

FIG. 1 shows a computer-implemented method for criteria-based generation of a configuration 10 of a virtual test VT for testing automated driving functions of a vehicle.

The method comprises defining S1 a dependency of configuration parameters 12a, 12b on target variables 14 of the virtual test VT.

Furthermore, the method comprises determining S2 a test algorithm A and/or parameter combinations 16 for the relevant target variable 14, and specifying S3 an application condition 18 for the configuration parameters 12a, 12b, at least one interval per parameter, and/or the test algorithm A.

Defining the dependency of the configuration parameters 12a, 12b on the target variables 14 of the virtual test VT for each target variable 14 comprises determining first configuration parameters 12a which have a significant impact on the relevant target variable 14 of the virtual test VT and determining second configuration parameters 12b which have an insignificant impact on the relevant target variable 14 of the virtual test VT.

Configuration parameters 12a, 12b are classified as first configuration parameters 12a when a difference in the relevant target variable 14 between using and not using the configuration parameter 12a, 12b exceeds a predetermined threshold value 20. Furthermore, configuration parameters 12a, 12b are classified as second configuration parameters 12a when the difference in the relevant target variable 14 between using and not using the configuration parameter 12a, 12b does not reach a predetermined threshold value 20.

In this regard, specifying the application condition 18 for the configuration parameters 12a, 12b, at least one interval per parameter, and/or the test algorithm A defines a point in time and/or time period for a parameter variation of the virtual test VT. The application condition 18 is a predetermined parameter range and/or a start and end point of an event, in particular a driving maneuver, of the virtual test VT.

By specifying a first test algorithm A for a first target variable 14, a first configuration 10 of the virtual test VT is carried out. Furthermore, by specifying a second test algorithm A for a second target variable 14, a second configuration 10 of the virtual test VT is carried out, wherein the first configuration 10 and the second configuration 10 of the virtual test VT are assigned to an identical test case.

The second configuration 10 of the virtual test VT is further linked to the first configuration 10 of the virtual test VT by a hierarchy condition 22. The hierarchy condition 22 is provided by a configuration parameter 12a, 12b of the first configuration 10, which impacts at least one configuration parameter 12a, 12b of the second configuration 10.

The configuration parameters 12a, 12b apply to at least one vehicle sensor and the application condition 18 applies to an error in the at least one vehicle sensor.

Furthermore, the configuration parameters 12a, 12b apply to a digital exchange of information among vehicles or between vehicles and a transport infrastructure, to environmental conditions, in particular weather conditions, to maneuvers by road users, to static objects, in particular items, to the transport infrastructure, to a roadway geometry and/or to a roadway state in the virtual test VT.

The target variable 14 is behavior of an ego vehicle, behavior of another road user, a time until a collision, and/or engagement or non-engagement of the automated driving function.

The target variable thus assesses the behavior of automated driving functions with regard to safety, comfort, and benefit.

An exemplary explanation of the method according to the invention is set out in the following.

The configuration parameters 12a, 12b of different layers are, for example, weather: rain. Initial velocity of ego vehicle and fellow vehicle, initial distances, and a bend radius of a roadway.

Division into different ITC configurations is then carried out.

ITC configuration A: weather: rain. Parameter variation: intensity of rain={DEFAULT: zero, light, moderate, heavy}. Key performance indicators (KPIs): no ABS engagement, no ESP engagement, fellow vehicle continually detected by camera sensor. ITC algorithm: “brute force” (use all values).

ITC configuration B: objects. Parameter variation: Vego=[50 km/h . . . DEFAULT: 100 km/h . . . 150 km/h], VFellow=[50 km/h . . . DEFAULT: 80 km/h . . . 150 km/h], distance between ego vehicle and fellow vehicle=[−80 m . . . DEFAULT: 0 m . . . +80 m], KPIs: time until collision>1 s, risk level>first ITC configuration: “SEA” (stochastic evolutionary algorithm for a search of the limits).

ITC configuration C: road level parameters. Parameter variation: bend radius=[10 m, 50 m, 100 m, DEFAULT: infinite]. KPIs: (lateral acceleration)<0.3 m/s². ITC algorithm: “brute force” (use all values).

The developer can determine the corresponding configuration parameters and value ranges from the requirements available to them.

The method according to an exemplary embodiment of the invention further assists with the input of the associated ITC configurations (A, B, C here) via a user interface or configuration language that supports the concept of scenario layers.

Example implementation of the ITC experiment:

Step I: variation of ITC configuration A. For ITC configuration B and C=> set default parameter values (known as “easy to manage”), only parameters of ITC configuration A=>vary in accordance with method (brute force in the example, try out all).

Move on to the next step, but if KPIs are noteworthy in any layer (threshold value reached or exceeded):

Option 1=>no further testing since problems would worsen for more challenging combinations of parameters in other layers; improve system under test (SUT) and restart at step I.

Option 2=>remove critical parameter values and move on to the next step.

Step II: variation of ITC configuration B. For ITC configuration A and C=> set default parameter values (known as “easy to manage”), only parameters of ITC configuration B=>vary in accordance with method (SEA in the example).

Move on to the next step, but if KPIs are noteworthy in any layer (threshold value reached or exceeded):

Option 1=>no further testing since problems would worsen for more challenging combinations of parameters in other layers; improve system under test (SUT) and restart at step I.

Option 2=>remove the critical parameter values and move on to the next step.

Step III: variation of ITC configuration C. For ITC configuration A and B=> set default parameter values (known as “easy to manage”), only parameters of ITC configuration C=>vary in accordance with method (brute force in the example, try out all).

Move on to the next step, but if KPIs are noteworthy in any layer (threshold value reached or exceeded):

Option 1=>no further testing since problems would worsen for more challenging combinations of parameters in other layers; improve system under test (SUT) and restart at step I.

Option 2=>remove the critical parameter values and move on to the next step.

Step IV: evaluation of the ITC experiment (can also optionally be done after each step).

Step V: reconfiguration and iteration. If the results are not satisfactory, the SUT needs to be improved and the process restarted at step I.

The set of removed parameter values is tracked and has to be empty at the end (as far as possible). If the results are satisfactory but critical parameter values have been removed from the value ranges, they must be added again once a promising solution for their management has been implemented (SUT update). Then restart at step I.

If the results are satisfactory and no further parameter values have been removed from the value ranges, the default parameter values are enhanced and the process is restarted at step I. The process is terminated as soon as the SUT is operating without any errors in the context of the ODD and the requirements.

The method according to an exemplary embodiment of the invention thus includes structuring and configuring a chain of linked modular-hierarchical individual ITC configurations which each have a low problem dimension (here “dimension” corresponds to the number of KPIs considered and parameters varied). This results in several advantages.

The configuration is clearer and is adapted to the problem by the modular-hierarchical structure. The implementation is more efficient since fewer simulation jobs are required (due to context and lower dimension).

The implementation is coupled to SUT development steps, with the requirements on the SUT being incrementally increased until they are acceptable. The results are more compact (lower dimensions) and easier to understand (due to modular-hierarchical structure and individual steps).

FIG. 2 is a schematic view of a system for criteria-based generation of a configuration 10 of a virtual test VT for testing automated driving functions of a vehicle according to an exemplary embodiment of the invention.

The system comprises a first arithmetic logic device 24, which is configured to define a dependency of configuration parameters 12a, 12b on target variables 14 of the virtual test VT.

Furthermore, the system comprises a second arithmetic logic device 26, which is configured to determine a test algorithm A and/or parameter combinations 16 for the relevant target variable 14, and a third arithmetic logic device 28, which is configured to specify an application condition 18 for the configuration parameters 12a, 12b, at least one interval per parameter, and/or the test algorithm A.

Although example embodiments have been illustrated and described herein, it will be appreciated that a multiplicity of alternative and/or equivalent implementations exist. It should be noted that the described embodiments are only examples and are not intended to be limiting.

It will be appreciated that various modifications may be made to the functionality and arrangement of elements without departing from the principles of the present disclosure.

Generally speaking, this application may cover modifications, adaptations, or variations to the embodiments set out herein. For example, an order of the method steps can be altered. Moreover, at least some parts of the method can be carried out in sequence or concurrently.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 System
10 Configuration
12a First configuration parameter
12b Second configuration parameter
14 Target variable
Parameter combination 16
18 Application condition
20 Threshold value
22 Hierarchy condition
24 First arithmetic logic device
26 Second arithmetic logic device
28 Third arithmetic logic device
A Test algorithm
VT Virtual test
S1-S3 Method steps

1. A method for criteria-based generation of a configuration of a virtual test for testing automated driving functions of a vehicle, the method comprising:
defining, by a configuration generation system, a dependency of configuration parameters on target variables of the virtual test;
determining, by the configuration generation system, a test algorithm and/or parameter combinations for a relevant target variable; and
specifying, by the configuration generation system, an application condition for the configuration parameters, at least one interval per parameter, and/or the test algorithm.

2. The method according to claim 1, wherein defining the dependency of the configuration parameters on the target variables of the virtual test comprises:
determining, for the relevant target variable, first configuration parameters which have a significant impact on the relevant target variable; and
determining, for the relevant target variable, second configuration parameters which have an insignificant impact on the relevant target variable.

3. The method according to claim 2, wherein configuration parameters are classified as first configuration parameters based on a difference in the relevant target variable between using and not using the configuration parameter exceeds a predetermined threshold value, and wherein configuration parameters are classified as second configuration parameters based on a difference in the relevant target variable between using and not using the configuration parameter does not reach a predetermined threshold value.

4. The method according to claim 1, wherein specifying the application condition for the configuration parameters, at least one interval per parameter, and/or the test algorithm defines a point in time and/or a time period for a parameter variation of the virtual test.

5. The method according to claim 1, wherein the application condition comprises:
a predetermined parameter range; and/or
a start point and an end point of an event of the virtual test.

6. The method according to claim 1, wherein, by specifying a first test algorithm for a first target variable, a first configuration of the virtual test is carried out, and wherein, by specifying a second test algorithm for a second target variable, a second configuration of the virtual test is carried out, wherein the first configuration and the second configuration of the virtual test are assigned to an identical test case.

7. The method according to claim 6, wherein the second configuration of the virtual test is linked to the first configuration of the virtual test by a hierarchy condition.

8. The method according to claim 7, wherein the hierarchy condition is provided by a configuration parameter of the first configuration that impacts at least one configuration parameter of the second configuration.

9. The method according to claim 1, wherein the configuration parameters apply to at least one vehicle sensor and the application condition applies to an error in the at least one vehicle sensor.

10. The method according to claim 1, wherein the configuration parameters apply to:
a digital exchange of information between vehicles,
a digital exchange of information between vehicles and a transport infrastructure, environmental conditions,
maneuvers by road users,
static objects,
the transport infrastructure,
a roadway geometry, and/or
a roadway state.

11. The method according to claim 1, wherein the target variable comprises:
behavior of an ego vehicle,
behavior of another road user,
a time until a collision, and/or
engagement or non-engagement of the automated driving function.

12. The method according to claim 1, wherein, based on a target variable of a configuration exceeding a predetermined threshold value, the virtual test is terminated and/or specific parameter values of the configuration are modified.

13. A system for criteria-based generation of a configuration of a virtual test for testing automated driving functions of a motor vehicle, the system comprising:
a first arithmetic logic device configured to define a dependency of configuration parameters on target variables of the virtual test;
a second arithmetic logic device configured to determine a test algorithm and/or parameter combinations for a relevant target variable; and
a third arithmetic logic device configured to specify an application condition for the configuration parameters, at least one interval per parameter, and/or the test algorithm.

14. A non-transitory computer-readable medium having processor-executable instructions stored thereon for criteria-based generation of a configuration of a virtual test for testing automated driving functions of a vehicle, wherein the processor-executable instructions, when executed, facilitate performance of the following:
defining, by a configuration generation system, a dependency of configuration parameters on target variables of the virtual test;
determining, by the configuration generation system, a test algorithm and/or parameter combinations for a relevant target variable; and
specifying, by the configuration generation system, an application condition for the configuration parameters, at least one interval per parameter, and/or the test algorithm.
